(19) United States
(12) Patent Application Publication
(10) Pub. No.: US 2014/0267986 A1
(43) Pub. Date: Sep. 18, 2014

(54) LIQUID CRYSTAL DISPLAY DEVICE

(71) Applicant: Japan Display Inc., Tokyo (JP)

(72) Inventors: Saori SUGIYAMA, Tokyo (JP); Masateru MORIMOTO, Tokyo (JP)

(73) Assignee: Japan Display Inc., Tokyo (JP)

(21) Appl. No.: 14/203,779

(22) Filed: Mar. 11, 2014

(30) Foreign Application Priority Data
Mar. 12, 2013 (JP) 2013-049053

(51) Int. Cl. G02F 1/1337

(52) U.S. Cl. CPC G02F 1/1337
USPC 349/106

(57) ABSTRACT

The black matrix has a shape in which a plurality of horizontal line portions which extend in the horizontal direction, and are aligned in the vertical direction, and a plurality of vertical line portions which extend in the vertical direction, and are aligned in the horizontal direction cross each other. The opening has a shape in which the convex portion is formed on one side, and a concave portion is formed on the other side in the horizontal direction. The spacer is arranged at an intersection portion of the vertical line portion and the horizontal line portion, by avoiding an intersection portion of the vertical line portion which is close to the convex portion of the opening at which a colored layer of a color having the highest transmittance is arranged and the plurality of horizontal line portions.

### CROSS-REFERENCE TO RELATED APPLICATION

The present application claims priority from Japanese application JP2013-49053 filed on Mar. 12, 2013, the content of which is hereby incorporated by reference into this application.

### BACKGROUND OF THE INVENTION

1. Field of the Invention

The present invention relates to a liquid crystal display device.

2. Description of the Related Art

A liquid crystal panel includes a pair of substrates, and a spacer is provided in one substrate in order to maintain a gap (space for filling in liquid crystal) between the substrates (JP 2005-345819 A). An alignment film is formed on surfaces which each substrate faces, and the alignment film is formed on the spacer. Accordingly, a convex portion is formed on the alignment film due to the spacer.

On the alignment film, unidirectional grooves are formed in order to arrange liquid crystal molecules unidirectionally. When there is a convex portion on the alignment film due to the spacer, alignment abnormality occurs in a rubbing process for forming the groove. The alignment abnormality occurs in a direction in which rubbing is performed (direction in which groove is formed). When the alignment abnormality occurs in a pixel region, the alignment abnormality causes leaking of light, lowering of contrast, or a failure such as streaks.

### SUMMARY OF THE INVENTION

An object of the present invention is to minimize influence of alignment abnormality.

(1) According to an aspect of the present invention, there is provided a liquid crystal display device which includes a first substrate; a black matrix which is formed on the first substrate so as to have a plurality of openings; colored layers of a plurality of colors which are formed on the first substrate so that any one of the colored layers is arranged in the respective openings, and configure a color filter; a plurality of spacers which are provided on the first substrate; a first alignment film which is formed on a surface of the first substrate on which the plurality of spacers are provided so that the first alignment film is placed on the plurality of spacers; a second substrate which faces the first substrate; a second alignment film which is formed on a surface of the second substrate which faces the first substrate; and a liquid crystal material which is arranged between the first alignment film and the second alignment film. The first alignment film is formed with convex portions which protrude in a direction of the second alignment film due to the plurality of spacers. The black matrix has a shape in which a plurality of horizontal line portions extend in a horizontal direction and are aligned in a vertical direction, and in which a plurality of vertical line portions extend in the vertical direction and are aligned in the horizontal direction, the plurality of horizontal line portions and the plurality of vertical line portions intersecting each other. The plurality of openings respectively have shapes in which the convex portion is formed on one side and a concave portion is formed on the other side in the horizontal direction. The respective spacers are arranged at an intersection portion of the vertical line portion and the horizontal line portion, by avoiding an intersection portion of the vertical line portion which is close to the convex portion of the opening at which the colored layer of a color having highest transmittance is arranged and the plurality of horizontal line portions. In the invention, since the convex portion is formed on the first alignment film due to the spacer, in the rubbing process, alignment abnormality occurs in a direction in which a rubbing process is performed from the concave portion. However, the spacer is arranged by avoiding the intersection portion of the vertical line portion which is close to the convex portion of the opening at which the colored layer of the color having the highest transmittance is arranged and the horizontal line portion. Accordingly, since the alignment abnormality which has the largest influence avoids the colored layer of the color having the highest transmittance, it is possible to suppress the influence to a minimum.

(2) In the liquid crystal display device which is described in (1), at least one of the spacers may be arranged at an intersection portion of the vertical line portion which is close to the convex portion of the opening at which the colored layer of a color having lowest transmittance is arranged and the horizontal line portion.

(3) In the liquid crystal display device which is described in (1) or (2), at least one of the spacers may be arranged at an intersection portion of the vertical line portion which is close to the concave portion of the opening at which the colored layer of a color having second lowest transmittance is arranged and the horizontal line portion.

(4) In the liquid crystal display device which is described in any one of (1) to (3), at least one of the spacers may be arranged at an intersection portion of the vertical line portion which is close to the convex portion of the opening at which the colored layer of a color having second lowest transmittance is arranged and the horizontal line portion.

(5) In the liquid crystal display device which is described in any one of (1) to (4), at least one of the spacers may be arranged at an intersection portion of the vertical line portion which is close to the concave portion of the opening at which the colored layer of the color having the highest transmittance is arranged and the horizontal line portion.

(6) In the liquid crystal display device which is described in any one of (1) to (5), the plurality of spacers may include a main spacer, and a sub-spacer which is lower than the main spacer.

(7) In the liquid crystal display device which is described in (6), the main spacer may be arranged at an intersection portion of the vertical line portion which is located between the convex portion of the opening at which the colored layer of the color having the lowest transmittance is arranged and the concave portion of the opening at which the colored layer of the color having the second lowest transmittance is arranged and the horizontal line portion; and the sub-spacer may be arranged at an intersection portion of the vertical line portion which is located between the convex portion of the opening at which the colored layer of the color having the second lowest transmittance is arranged and the concave portion of the opening at which the colored layer of the color having the highest transmittance is arranged and the horizontal line portion.

### BRIEF DESCRIPTION OF THE DRAWINGS

FIG. 1 is a cross-sectional view which illustrates a liquid crystal display device according to a first embodiment of the present invention.

FIG. 2 is a plan view which illustrates a part of the liquid crystal display device illustrated in FIG. 1.

FIG. 3 is a cross-sectional view which is taken along line of the liquid crystal display device illustrated in FIG. 2.

FIG. 4 is a diagram which illustrates a modification example of the liquid crystal display device according to the first embodiment.

FIG. 5 is a cross-sectional view which illustrates a liquid crystal display device according to a second embodiment of the present invention.

FIG. 6 is a plan view which illustrates a part of the liquid crystal display device illustrated in FIG. 5.

### DETAILED DESCRIPTION OF THE INVENTION

Hereinafter, embodiments of the present invention will be described with reference to drawings.

### First Embodiment

FIG. 1 is a cross-sectional view which illustrates a liquid crystal display device according to a first embodiment of the present invention. The liquid crystal display device includes a first substrate 10 which is a light transmissive substrate such as a glass substrate, for example. A black matrix 12 is formed in the first substrate 10.

FIG. 2 is a plan view which illustrates a part of the liquid crystal display device which is illustrated in FIG. 1. In addition, FIG. 1 is a cross-sectional view which is taken along line I-I in FIG. 2. The black matrix 12 has a shape in which a plurality of horizontal line portions 14 which extend in the horizontal direction (transverse direction in FIG. 2), and are aligned in the vertical direction (longitudinal direction in FIG. 2) and a plurality of vertical line portions 16 which extend in the vertical direction, and are aligned in the horizontal direction are intersected with each other. According to the embodiment, the vertical direction and the horizontal direction are orthogonal to each other. In the example in FIG. 2, the width of the horizontal line portion 14 is larger than the width of the vertical line portion 16 (width orthogonal to extending direction).

The black matrix 12 includes a plurality of openings 18. Each opening 18 is a sub-pixel, and a pixel is configured of a plurality of sub-pixels. The plurality of openings 18 have a shape which includes a convex portion 20 at one side, and a concave portion 22 on the other side in the horizontal direction, respectively. In other words, the vertical line portion 16 of the black matrix 12 bends between neighboring horizontal line portions 14. The reason why the black matrix 12 has such a shape is that a multi-domain system for enlarging a viewing angle is applied.

FIG. 3 is a cross-sectional view which is taken along line III-III of the liquid crystal display device illustrated in FIG. 2. In the multi-domain system, two or more regions in which orientation states of liquid crystal molecules are different are present in one pixel. By a protrusion P, a plurality of division regions DA of which orientation states are different are partitioned.

As illustrated in FIG. 1 or 2, colored layers 24 of a plurality of colors are formed on the first substrate 10 so that any of the colored layers is arranged at the respective openings 18 of the black matrix 12. The plurality of colored layers 24 configure a color filter. The plurality of colors are a red color (R), a green color (G), and a blue color (B). The green (G) colored layer 24 has the highest light transmittance, and also has high visibility. The blue (B) colored layer 24 has the lowest transmittance, and also has low visibility. The colored layers 24 of the plurality of colors are aligned in a direction which the convex portion 20 of the opening 18 of the black matrix 12 faces (right direction in FIG. 2) in order of the red color (R), the green color (G), and the blue color (B). In addition, the respective colored layers 24 are formed in a band shape along the vertical line portion 16, and as illustrated in FIG. 1, are overlapped with the horizontal line portion 14. The colored layers 24 are covered with a planarization layer 26.

A plurality of spacers 28 are provided on the first substrate 10. Specifically, the plurality of spacers 28 are provided on the planarization layer 26. A first alignment film 30 is provided on a surface of the first substrate 10 on which the plurality of spacers 28 are provided so as to be placed on the plurality of spacers 28. The first alignment film 30 has a protrusion portion 32 due to the plurality of spacers 28. As illustrated in FIG. 2, the width of the tip end surface of the spacer 28 (surface on first alignment film 30 side) (width in direction in which horizontal line portion 14 extends) is larger than the width of the vertical line portion 16 (width in direction in which horizontal line portion 14 extends). In addition, the width of the tip end surface of the protrusion portion 32 (width in direction in which horizontal line portion 14 extends) of the first alignment film 30 is also larger than the width of the vertical line portion 16 (width in direction in which horizontal line portion 14 extends).

The liquid crystal display device includes a second substrate 34 which is a light transmissive substrate such as a glass substrate, for example. The second substrate 34 faces the first substrate 10. A second alignment film 36 is formed on a surface of the second substrate 34 facing the first substrate 10. A cell gap is formed between the first alignment film 30 and the second alignment film 36 due to the spacer 28 (or protrusion portion 32 which protrudes in direction from first alignment film 30 to second alignment film 36). A liquid crystal material 38 is arranged between the first alignment film 30 and the second alignment film 36.

As illustrated in FIG. 2, the spacer 28 is arranged at an intersection portion of the vertical line portion 16 and the horizontal line portion 14 of the black matrix 12. Since the first alignment film 30 which is illustrated in FIG. 1 includes the protrusion portion 32 which protrudes in a direction of the second alignment film 36 due to the spacer 28, an alignment abnormality region 40 which is illustrated in FIG. 2 is formed in a rubbing process. The alignment abnormality region 40 is formed along the rubbing direction from the spacer 28, or the protrusion portion 32. The rubbing direction is a direction in which the vertical line portion 16 of the black matrix 12 extends (direction orthogonal to direction in which horizontal line portion 14 extends). The rubbing direction is the linear direction.

The alignment abnormality region 40 and the vertical line portion 16 are overlapped. Since the width of the tip end surface of the protrusion portion 32 of the first alignment film 30 is larger than the width of the vertical line portion 16, the alignment abnormality region 40 protrudes from the vertical line portion 16. That is, a part of the alignment abnormality region 40 is also overlapped with the opening 18 of the black matrix 12. Specifically, the alignment abnormality region 40 is overlapped with a convex portion 20 of one opening 18 and a concave portion 22 of the other opening 18 between a pair of openings 18 which interposes the vertical line portion 16. An overlapping region of the alignment abnormality region 40 with the convex portion 20 is larger than an overlapping region of the alignment abnormality region 40 with the concave portion 22. Accordingly, the overlapping region of the alignment abnormality region 40 with the convex portion 20 has a large influence on a display quality.

The spacer 28 is arranged by avoiding an intersection portion of a vertical line portion 16 which is close to the convex portion 20 of the opening 18 at which the colored layer 24 of a color (G) having the highest transmittance is arranged and the plurality of horizontal line portions 14. That is, it is set such that the alignment abnormality region 40 is not overlapped with the convex portion 20 of the opening 18 at which the colored layer 24 of the color (G) having the highest transmittance, and having a large influence on the display quality is arranged.

According to the embodiment, since the convex portion 20 is formed on the first alignment film 30 due to the spacer 28, the alignment abnormality occurs in a direction in which the rubbing process is performed, from the convex portion 20, in the rubbing process. However, the spacer 28 is arranged by avoiding the intersection portion of the vertical line portion 16 which is close to the convex portion 20 of the opening 18 at which the colored layer 24 of the color (G) having the highest transmittance is arranged and the horizontal line portion 14. Accordingly, since the alignment abnormality with the largest influence (on the display quality) avoids the colored layer 24 of the color (G) having the highest transmittance, it is possible to minimize the influence.

The plurality of spacers 28 include a plurality of first spacers 28A and a plurality of second spacers 28B. The first spacer 28A is arranged at an intersection portion of a vertical line portion 16 which is close to a convex portion 20 of an opening 18 at which a colored layer 24 of a color (B) having the lowest transmittance is arranged and the horizontal line portion 14. That is, it is set such that the alignment abnormality region 40 is overlapped with the convex portion 20 of the opening 18 at which the colored layer 24 of the color (B) having the lowest transmittance with the smallest influence on the display quality is arranged. In addition, the first spacer 28A is arranged at an intersection portion of a vertical line portion 16 which is close to a concave portion 22 of an opening 18 at which a colored layer 24 of a color (R) having the second lowest transmittance is arranged and the horizontal line portion 14.

The second spacer 28B is arranged at an intersection portion of a vertical line portion 16 which is close to a convex portion 20 of the opening 18 at which the colored layer 24 of the color (R) having the second lowest transmittance is arranged and the horizontal line portion 14. The second spacer 28B is arranged at an intersection portion of a vertical line portion 16 which is close to a concave portion 22 of an opening 18 at which the colored layer 24 of the color (G) having the highest transmittance is arranged and the horizontal line portion 14. That is, the alignment abnormality region 40 is also overlapped with the opening 18 at which the colored layer 24 of the color (G), having the highest transmittance, and having the largest influence on the display quality is arranged, however, since the alignment abnormality region 40 is overlapped with the concave portion 22, an overlapping region becomes small compared to a case of being overlapped with the convex portion 20, accordingly, the influence on the display quality becomes small.

### Modification Example

FIG. 4 is a diagram which illustrates a modification example of the liquid crystal display device according to the first embodiment. In the example, a first spacer 128A is arranged at an intersection portion of a vertical line portion 116 which is close to a convex portion 120 of an opening 118 at which a colored layer 124 of a color (R) having the second lowest transmittance is arranged and a horizontal line portion 114. The first spacer 128A is arranged at an intersection portion of the vertical line portion 116 which is close to a concave portion 122 of an opening 118 at which a colored layer 124 of a color (B) having the lowest transmittance is arranged and the horizontal line portion 114.

According to the modification example, the colored layers 124 of a plurality of colors are aligned in order of a red color (R), a blue color (B), and a green color (G) in a direction which the convex portion 120 of the opening 118 of a black matrix 112 faces (right direction in FIG. 4).

A second spacer 128B is arranged at an intersection portion of a vertical line portion 116 which is close to a convex portion 120 of an opening 118 at which the colored layer 124 of a color (B) having the lowest transmittance is arranged and the horizontal line portion 114. The second spacer 128B is arranged at an intersection portion of a vertical line portion 116 which is close to a concave portion 122 of an opening 118 at which the colored layer 124 of a color (G) having the highest transmittance is arranged and the horizontal line portion 114.

The present invention does not exclude such an example, and the same operational effect can be obtained from a configuration which is the same as that in the above described embodiment.

### Second Embodiment

FIG. 5 is a cross-sectional view which illustrates a liquid crystal display device according to a second embodiment of the present invention. FIG. 6 is a plan view which illustrates a part of the liquid crystal display device illustrated in FIG. 5. In addition, FIG. 5 is a cross-sectional view which is taken along line V-V in FIG. 6. As illustrated in FIG. 5, a plurality of spacers 228 include a main spacer 228A and a sub-spacer 228B which are lower than the main spacer 228A. A cell gap is secured by the main spacer 228A, and the sub-spacer 228B takes a role of a stopper when an external force is applied in a direction in which the cell gap is contracted. A first alignment film 230 comes into contact with a second alignment film 236 in a main protrusion portion 232A which is formed due to the main spacer 228A, however, there is a gap between a sub-protrusion portion 232B which is formed due to the sub-spacer 228B and the second alignment film 236.

In the embodiment, as well, an alignment abnormality region 240 is formed from the main protrusion portion 232A and the sub-protrusion portion 232B. The higher the height of a protrusion which is formed in the first alignment film 230, the higher the degree of the alignment abnormality. That is, the degree of the alignment abnormality in the alignment abnormality region 240 which is formed due to the main protrusion portion 232A is higher than the degree of the alignment abnormality in the alignment abnormality region 240 which is formed due to the sub-protrusion portion 232B.

According to the embodiment, colored layers 224 of a plurality of colors are aligned in order of a red color (R), a green color (G), and a blue color (B), in a direction which a convex portion 220 of an opening 218 of a black matrix 212 faces (right direction in FIG. 6).

As illustrated in FIG. 6, the main spacer 228A is arranged at an intersection portion of a vertical line portion 216 which is located between a convex portion 220 of an opening 218 at which a colored layer 224 of a color (B) having the lowest transmittance is arranged and a concave portion 222 of an opening 218 at which a colored layer 224 of a color (R) having the second lowest transmittance is arranged and a horizontal line portion 214. That is, the alignment abnormality region 240 is overlapped with the convex portion 220 of the opening 218 at which the colored layer 224 of the color (B), having the lowest transmittance, and having the smallest influence on the display quality is arranged.

The sub-spacer 228B is arranged at an intersection portion of a vertical line portion 216 which is located between a convex portion 220 of an opening 218 at which the colored layer 224 of the color (R) having the second lowest transmittance is arranged and a concave portion 222 of an opening 218 at which a colored layer 224 of a color (G) having the highest transmittance is arranged and the horizontal line portion 214. That is, the alignment abnormality region 240 is also overlapped with the opening 218 at which the colored layer 224 of the color (G), having the highest transmittance, and having the largest influence on the display quality is arranged, however, since the alignment abnormality region 240 is overlapped with the concave portion 222, the overlapping region becomes small, and the influence on the display quality is small.

According to the embodiment, the alignment abnormality region 240 which is formed due to the main protrusion portion 232A of which a degree of alignment abnormality is high is overlapped with the convex portion 220 of the opening 218 at which the colored layer 224 of the color (B), having the lowest transmittance, and having a small influence on the display quality is arranged. Accordingly, it is possible to minimize the influence on the display.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device comprising:
a first substrate;
a black matrix which is formed on the first substrate so as to have a plurality of openings;
colored layers of a plurality of colors which are formed on the first substrate so that any one of the colored layers is arranged in the respective openings, and configure a color filter;
a plurality of spacers which are provided on the first substrate;
a first alignment film which is formed on a surface of the first substrate on which the plurality of spacers are provided so that the first alignment film is placed on the plurality of spacers;
a second substrate which faces the first substrate;
a second alignment film which is formed on a surface of the second substrate which faces the first substrate; and
a liquid crystal material which is arranged between the first alignment film and the second alignment film,
wherein the first alignment film is formed with convex portions which protrude in a direction of the second alignment film due to the plurality of spacers,
wherein the black matrix has a shape in which a plurality of horizontal line portions extend in a horizontal direction and are aligned in a vertical direction, and in which a plurality of vertical line portions extend in the vertical direction and are aligned in the horizontal direction, the plurality of horizontal line portions and the plurality of vertical line portions crossing each other,
wherein the plurality of openings respectively have shapes in which the convex portion is formed on one side and a concave portion is formed on the other side in the horizontal direction, and
wherein the respective spacers are arranged at an intersection portion of the vertical line portion and the horizontal line portion, by avoiding an intersection portion of the vertical line portion which is close to the convex portion of the opening at which the colored layer of a color having highest transmittance is arranged and the plurality of horizontal line portions.

2. The liquid crystal display device according to claim 1,
wherein at least one of the spacers is arranged at an intersection portion of the vertical line portion which is close to the convex portion of the opening at which the colored layer of a color having lowest transmittance is arranged and the horizontal line portion.

3. The liquid crystal display device according to claim 1,
wherein at least one of the spacers is arranged at an intersection portion of the vertical line portion which is close to the concave portion of the opening at which the colored layer of a color having second lowest transmittance is arranged and the horizontal line portion.

4. The liquid crystal display device according to claim 1,
wherein at least one of the spacers is arranged at an intersection portion of the vertical line portion which is close to the convex portion of the opening at which the colored layer of a color having second lowest transmittance is arranged and the horizontal line portion.

5. The liquid crystal display device according to claim 1,
wherein at least one of the spacers is arranged at an intersection portion of the vertical line portion which is close to the concave portion of the opening at which the colored layer of the color having the highest transmittance is arranged and the horizontal line portion.

6. The liquid crystal display device according to claim 1,
wherein the plurality of spacers include a main spacer, and a sub-spacer which is lower than the main spacer.

7. The liquid crystal display device according to claim 6,
wherein the main spacer is arranged at an intersection portion of the vertical line portion which is located between the convex portion of the opening at which the colored layer of a color having the lowest transmittance is arranged and the concave portion of the opening at which the colored layer of a color having the second lowest transmittance is arranged and the horizontal line portion, and
wherein the sub-spacer is arranged at an intersection portion of the vertical line portion which is located between the convex portion of the opening at which the colored layer of a color having the second lowest transmittance is arranged and the concave portion of the opening at which the colored layer of the color having the highest transmittance is arranged and the horizontal line portion.
